(19) United States
(12) Patent Application Publication
(10) Pub. No.: US 2026/0145225 A1
(43) Pub. Date: May 28, 2026

(54) SAND CORE AND SAND CORE MAKING METHOD

(71) Applicant: LORAMENDI, S.COOP., Vitoria-Gasteiz (ES)

(72) Inventors: Luis Alfonso FERNANDEZ ORIVE, Vitoria-Gasteiz (ES); Imanol BASTERRETXEA ALONSO, Vitoria-Gasteiz (ES); Alexandra ALLUE SALVADOR, Zamudio (ES); Patricia ARES ELEJOSTE, Zamudio (ES); Lorena GERMAN AYUSO, Zamudio (ES)

(21) Appl. No.: 19/411,725

(22) Filed: Dec. 8, 2025

Related U.S. Application Data
(63) Continuation of application No. PCT/EP2024/065292, filed on Jun. 4, 2024.

(30) Foreign Application Priority Data
Jun. 8, 2023 (EP) 23382568.6

(51) Int. Cl. B22C 9/10; B22C 1/18; B22C 9/02; B33Y 10/00; B33Y 70/00; B33Y 80/00

(52) U.S. Cl. CPC B22C 9/10; B22C 1/185; B22C 9/02; B33Y 10/00; B33Y 70/00; B33Y 80/00

(57) ABSTRACT

A sand core including a sand granular material, at least one binder and an additive selected from a compound of the phosphinate group. Method of making sand cores including a first step of contacting or mixing a granular sand material and at least one binder and a second curing step, wherein the granular sand material or the mixture of granular material and/or binder includes an additive selected from a compound of the phosphinate group.

### CROSS-REFERENCE TO RELATED APPLICATIONS

This application relates to and claims the benefit and priority to International Application No. PCT/EP2024/065292, filed Jun. 4, 2024, which claims priority to European Patent Application No. 23382568.6, filed Jun. 8, 2023, each of which is incorporated herein by reference in its entirety.

### TECHNICAL FIELD

The present invention relates to compositions and methods of making sand cores.

### BACKGROUND

Sand cores are generally manufactured on conventional sand making machines, where a mold defines the shape of the core to be manufactured in each manufacturing cycle (or of the cores to be manufactured). The material used to make the cores is then poured into the mold, and the material is hardened or cured to make the result solid. The result is the sand core. The material used is a granular material, a binding compound and a binder (e.g. a type of resin). Examples of machines where sand cores are made in this way can be found for example in EP0494762A2 and EP2907601A1, of the same applicant.

Another way of manufacturing sand cores is by using additive manufacturing. This type of manufacturing consists of several steps: a first step of applying a plurality of layers of granular sand material with a binding compound and a plurality of layers of a binder or resin in an interleaved manner on a working platform and a second step of curing these layers by increasing the temperature of the layers, preferably by a heat input method (heat or microwave), dehydration or a combination of both methods. This type of manufacturing is carried out on additive manufacturing machines, which comprise a working table, a printing assembly comprising printheads which are arranged above the working table and which are configured to deposit the layers of granular material or binder.

Sand cores are typically used to manufacture metal castings with very specific dimensional tolerances and very narrow acceptance deviation ranges, often between 0.15 mm and 0.5 mm. Core manufacturers therefore need to ensure dimensional stability of the core during use, so that the metal part obtained from casting meets the required dimensional tolerances, for example, in the manufacturing of cooling jackets, cylinder head parts, engine blocks, disc brakes or drive shafts.

### SUMMARY

Disclosed are sand cores and methods of making sand cores.

A first aspect of the invention relates to a sand core comprising a granular sand material, at least one binder and an additive selected from a compound of the phosphinate group.

A second aspect of the invention relates to a method of making sand cores comprising a first contacting or mixing step of a granular sand material and at least one binder on a support, and a second step of curing, wherein the granular sand material or the mixture of granular sand material and the binder comprises an additive selected from a compound of the phosphinate group.

One of the problems with sand cores is that during their use in the process of obtaining metal parts by casting, they are not dimensionally stable due to the fact that the core expands and/or deforms under the effect of heat. This leads to the manufacturing of defective metal parts as they do not meet the required dimensional tolerances.

Thanks to the addition of the phosphinate group compound, a better dimensional stability of the sand core in use is achieved. It has been seen that when the sand core of the invention is subjected to the temperatures of the molten metal, which usually exceed 600° C., the dimensions of the sand core remain within the specified ranges for a longer time, as it is able to better withstand the temperature conditions of use, delaying the expansion and/or deformation of the sand core. This favours compliance with the dimensional tolerances of the metal parts obtained by casting with sand cores, with the consequent improvement in manufacturing performance and compliance with the quality requirements of the metal parts manufactured with these cores.

These and other advantages and features will become apparent in view of the figures and the detailed description.

### BRIEF DESCRIPTION OF THE DRAWINGS

FIG. 1 shows the steps of making sand cores according to one embodiment.

FIG. 2 shows a working box comprising a working platform with a plurality of cores generated according to an embodiment.

FIG. 3 shows a graph representing the deviation of the measurement points of a core of a formulation without additives.

FIG. 4 shows a graph representing the deviation of the core measurement points of a formulation with aluminium diethylphosphinate.

FIGS. 5A and 5B shows two graphs representing the deviation of the core measurement points of a formulation with zeolite and one with zeolite and aluminium diethylphosphinate.

FIGS. 6A and 6B shows two graphs representing the deviation of the core measurement points of a formulation with wollastonite and one with wollastonite and aluminium diethylphosphinate.

FIGS. 7A and 7B shows two graphs representing the deviation of the core measurement points of a formulation with lithium carbonate and with lithium carbonate and aluminium diethylphosphinate.

FIGS. 8A and 8B shows two graphs representing the deviation of the core measurement points of a formulation with sodium borate and with sodium borate and aluminium diethylphosphinate.

FIGS. 9A and 9B shows two graphs representing the deformation of a core specimen with a formulation containing aluminium diethylphosphinate and one without diethylphosphinate. The first graph represents data from specimens obtained by additive manufacturing and the second graph represents data from specimens obtained by a blow-molding machine method.

### DETAILED DESCRIPTION

A first aspect of the invention relates to a sand core comprising a granular sand material, a binder and an additive selected from a compound of the phosphinate group, preferably, a metal salt of phosphinic acid. In a preferred embodiment, the compound is an aluminium diethylphosphinate, the latter being marketed for example under the brand name Exolit OP 1230™ (hereinafter Exolit). The inventors have found that the use of the phosphinate presents surprising data in terms of dimensional stability in use of the core, as can be seen in Example 3. The core comprising the phosphinate has greater resistance to embrittlement, to expansion and to deformation under conditions of casting temperatures than a core not comprising the phosphinate.

“Dimensional stability in use” means the ability of the core to maintain its dimension during the casting process within the established dimensional specifications. In the case of the invention, it is determined by a Hot Distortion test.

In one embodiment, the sand core comprises a second additive selected from zeolite and/or wollastonite and/or lithium carbonate and/or sodium borate or a mixture thereof. As shown in Example 2, this second additive has advantages in the core, especially in the core obtained by the additive manufacturing method.

Regarding the sand granular material, which is the majority part of the core composition, in one embodiment, the type of sand can be selected from silica sand, chromite sand, zircon sand, olivine sand, bauxite, mullite and/or any sand of synthetic character or a mixture of one or more of the same. Regarding the sand grain size, it preferably has a diameter of between 100 μm and 425 μm. The particle or grain size will depend on the type of manufacturing method by which it is obtained. Thus, in a preferred embodiment, when it is a sand core obtained by additive manufacturing, the sand grain may have a diameter between 100 μm and 300 μm, preferably between 100 μm and 160 μm. In another embodiment, when it is a sand core obtained by conventional sand making machines, the sand grain may have a diameter between 160 μm and 425 μm.

The diameter or grain or particle size in the invention is measured by the sieving method.

Regarding the binder, in a preferred embodiment the binder is inorganic.

In the embodiment comprising the inorganic binder it is common for it to comprise at least one binder compound. Thus, in this embodiment, one relation, the core comprises a binding compound consisting of a set of metal oxide particles, which is selected from the group of silicon dioxide, aluminium oxide, titanium oxide and zinc oxide, with a particle size that can be between 0.10 μm and 1 μm, preferably the binding compound being silicon dioxide. These particles bind with the surface of the sand grain and the binder to establish bonds with each other. The particles of the binder compound surround the sand grains, so that the binder reacts with the sand grains, creating bridges between the different particles located on different grains.

A second aspect of the invention relates to a method of making sand cores, more specifically, the sand core of the invention, which may be a making method using conventional machines or by additive manufacturing. The method of making comprises a first step of contacting or mixing a binder and a granular sand material and optionally a binding compound when the binder is an inorganic binder, on the surface of a support and a second step of curing. The granular sand material or the mixture of binder, granular material and binding compound, if included, comprises an additive selected from a compound of the phosphinate group, preferably metal phosphinates, most preferably aluminium diethylphosphinate. Regarding the amount of this compound from the group of phosphinates, in a preferred embodiment, the percentage by weight of the compound with respect to the granular sand material is between 0.01 and 0,045%, preferably between 0.01 and 0.03%, very preferably between 0.01 and 0.02%.

In one embodiment, in addition to the first additive, the sand granular material or the mixture of the binder, the granular material and the binder compound where applicable, preferably the mixture of granular material and the binder compound where included, comprises a second additive selected from zeolite and/or wollastonite and/or lithium carbonate and/or sodium borate or a mixture thereof. In one embodiment, the percentage by weight of the second additive with respect to the granular sand material is between 0.1 and 0.6%.

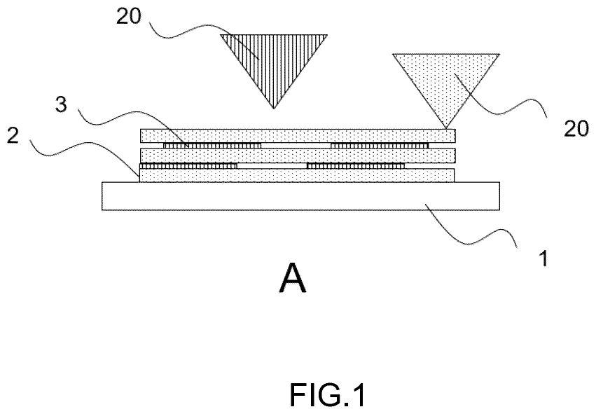

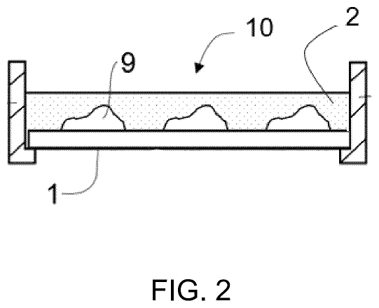

When the method of making is a method of making sand cores by additive manufacturing, the first step of contacting is by applying a plurality of layers of a mixture 2 of granular sand material, the binder compound if any, and the phosphinate group compound (granular mixture 2) and a plurality of layers of the binder 3 in an interleaved manner on the surface 1 of a working platform 10, which is subsequently subjected to a curing step of said layers by increasing the temperature of layers, preferably by a heat input or dehydration method, as shown in FIG. 1. In more detail, a granular mixture 2 is first obtained by mixing the granular sand material, the binder compound if any, and the compound of the phosphinate group and a first layer of this granular mixture 2 is deposited on the working platform 1. Subsequently, a binder 3 is applied to the required regions of the previously deposited layer of granular mixture 2 to produce a layer of solidified granular material, and the two previous steps are repeated as many times as required to generate as many layers of solidified granular material on top of each other as required, forming these layers of solidified granular material on top of each other the sand core which will subsequently undergo the second curing step. The deposition of the layers of granular mixture 2 and binder 3 is normally carried out with separate printing machine heads 20 known by the person skilled in the art, the heads being arranged above the working platform 1 and being configured to deposit the layers of granular mixture 2 and binder 3 on the corresponding layer of granular mixture. FIG. 2 shows a working box 10 comprising a working platform with a plurality of cores 9 manufactured according to this embodiment of the invention, surrounded by uncured granular mixture 2. Subsequent to the curing step, the uncured granular mixture 2 is removed. The method of the invention can be applied by any equipment for additive manufacturing of sand parts by use of binder.

In a preferred embodiment, the first additive and/or the second additive are incorporated into the sand granular material. The fact that the additive(s) are incorporated in the sand granules rather than in the binder facilitates the additive manufacturing process. Mixing the additives into the sand granular material is much simpler than into the binder, and any solidification of sand in the outlet ports of the headers typically used to apply the binder coatings is avoided or minimised.

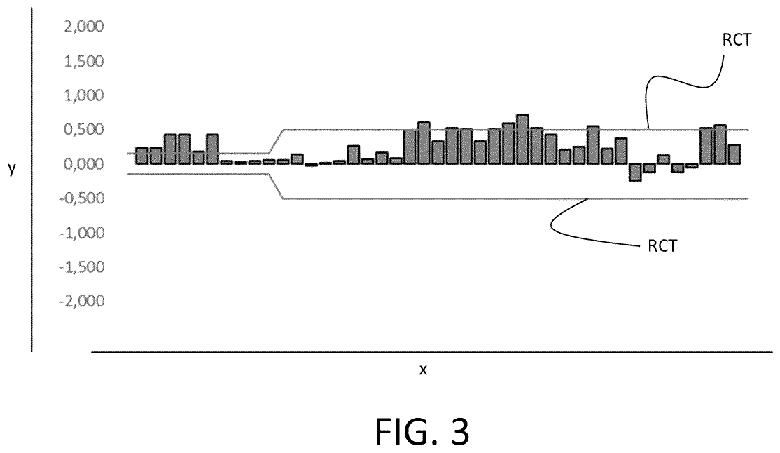

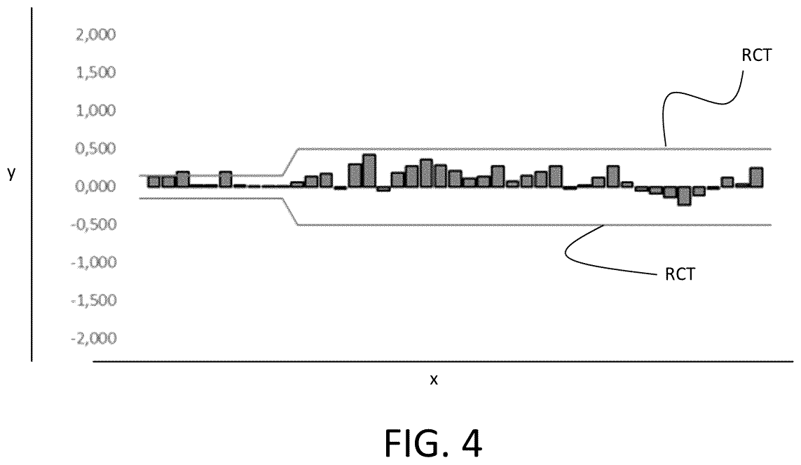

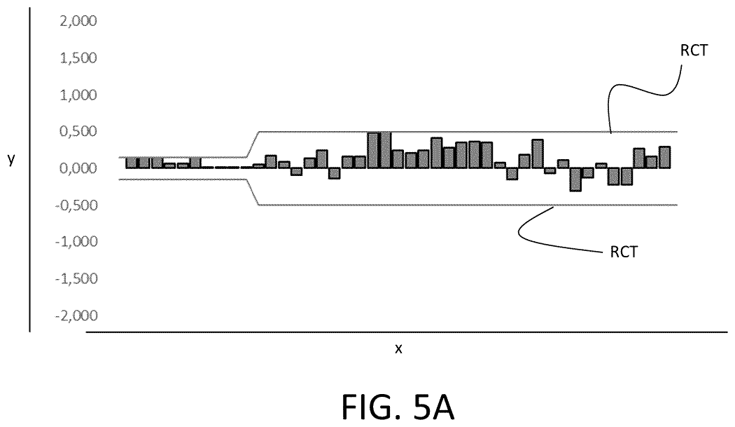

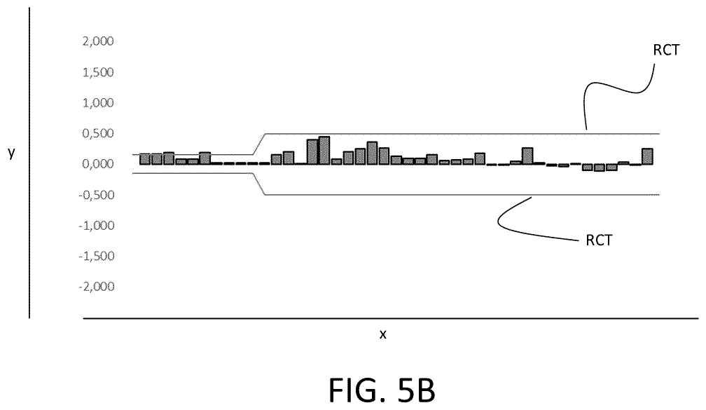

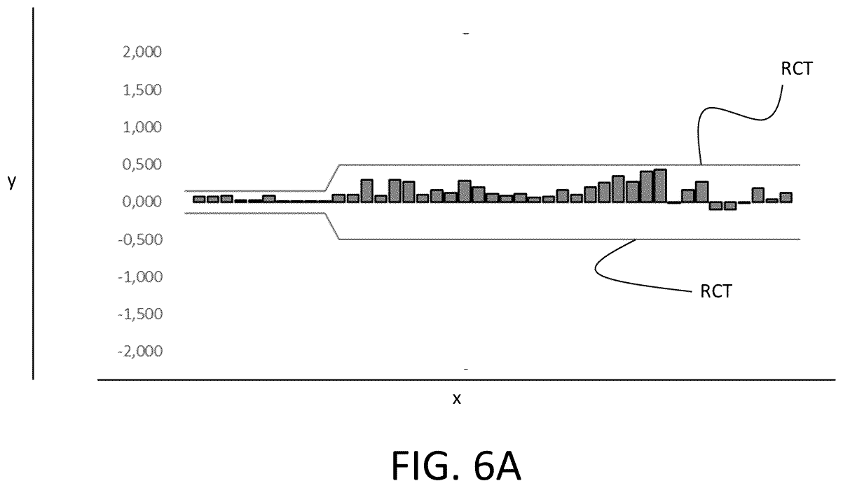

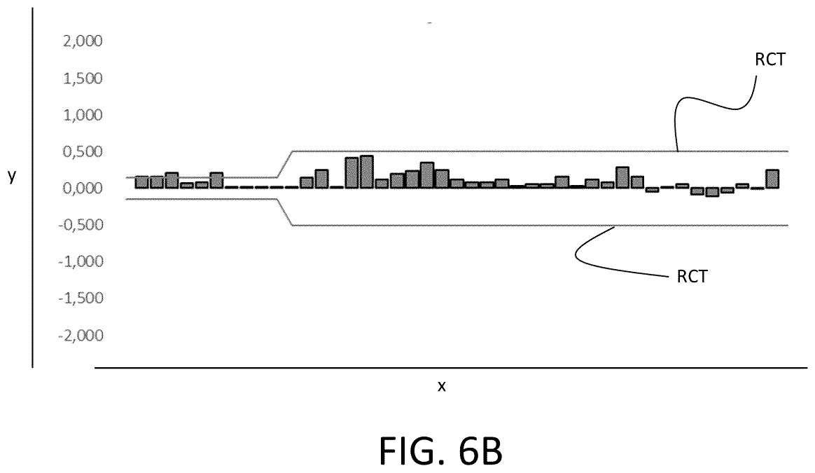

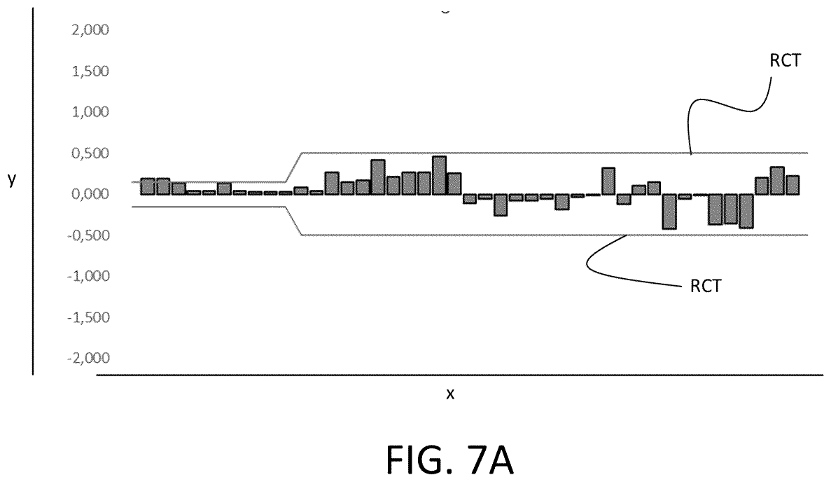

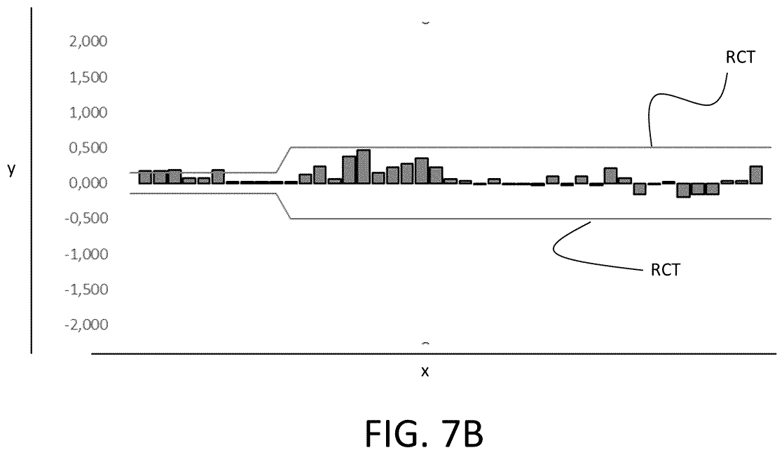

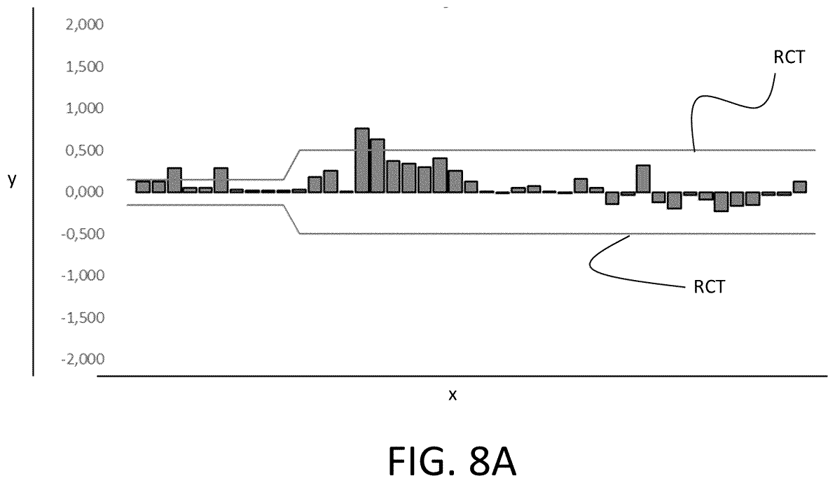

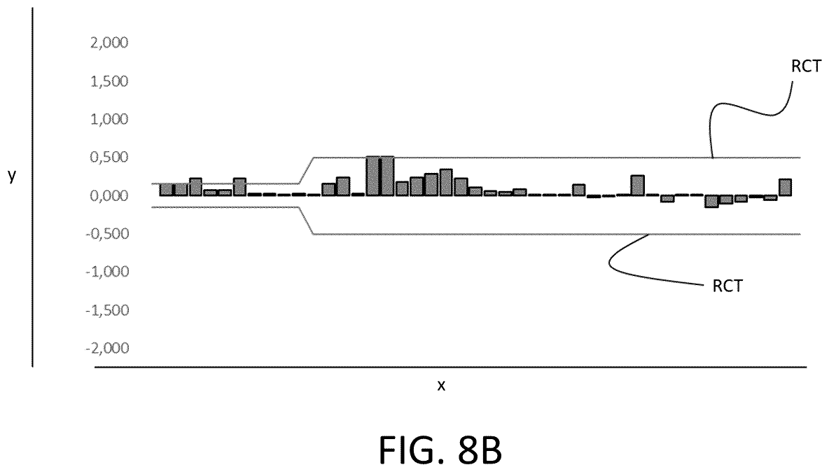

As can be seen in Example 2 and FIGS. 3 to 8, in the case of additive manufacturing, the addition of the first and/or second additive has an additional advantage, allowing for better dimensional stability of core manufacturing.

Manufacturing dimensional stability is understood as the ability of the core to meet dimensional tolerances after the solidification and/or curing process. In the case of the invention, it is determined by comparing the dimensions of a manufactured core against the ideal model represented by a CAD software design of the core.

The inventors have found that the compound from the phosphinate group, and preferably aluminium diethylphosphinate, presents surprising data in terms of dimensional stability, as can be seen in Example 2. During the experimental phase they have found that aluminium diethylphosphinate increases the viscosity of the granular mixture, speeding up the solidification process of the sand granulate, occurring in a shorter time. This results in a higher consistency of the layers of the granular mixture after printing, having an effect on the dimensional stability of the final core. On the other hand, it has also been found to have an effect on the wettability of the granular material. The presence of this additive in the granular sand material makes the sand have a greater power to absorb the binder in a more homogeneous way, allowing a better penetration of the binder in the sand, and therefore, obtaining a greater control over the effect of the binder and, therefore, in the solidification process.

Regarding the type of sand in the granular material, in a preferred embodiment of the additive manufacturing method, the sand is selected from silica sand, chromite sand, zircon sand, olivine sand, bauxite sand, mullite sand and/or any synthetic sand. For best optimisation, the sand has a grain or particle diameter between 100 μm and 300 μm, preferably between 100 μm and 160 μm.

With respect to the binder, in one embodiment, the binder is an inorganic binder. In a preferred embodiment, the binder is a resin comprising sodium silicate and water, with a sodium silicate/water ratio by volume comprised in the range of 20:80 and 45:55, all possible ratios being included, provided that it comprises the minimum or maximum of the aforementioned sodium silicate part. With regard to the ratio of binder to granular sand material, in a preferred embodiment, the percentage by weight of binder to granular sand material is between 1.5% and 6%. In the case of an additive manufacturing method, preferably the range is between 2.5% and 6%. In the case of a conventional machine method, this range is preferably between 1.5% and 2.5%.

Regarding the binder compound, it is selected from the group of silicon dioxide, aluminium oxide, titanium oxide and zinc oxide, in a preferred embodiment silicon dioxide. In terms of size, the binder compound has a particle size that can be between 0.10 μm and 1 μm. The binder compound is preferably used in embodiments where the binder is inorganic.

Regarding the ratio of binder compound to granular sand material, in a preferred embodiment, the percentage by weight of binder compound to granular sand material is between 0.4% and 1.8%. In the case of an additive manufacturing method, preferably the range is between 0.4% and 1.2%. In the case of a conventional machine method, this range is preferably between 0.6% and 1.8%.

Another aspect of the invention relates to a sand core obtainable according to the making method of the invention for use in metal casting, preferably iron, aluminium, copper or aluminium casting. These cores can be used in the manufacture of cooling jacket parts, cylinder head parts, engine blocks, disc brakes or drive shafts by casting.

Another aspect of the invention relates to a composition for the making of sand cores, preferably by additive manufacturing, comprising granular sand material, optionally a binding compound and a first additive selected from a compound from the group of phosphinates and/or zeolite and/or wollastonite and/or lithium carbonate and/or sodium borate or a mixture thereof. This composition of the invention can be used in the method of the invention for obtaining the core of the invention.

In a preferred embodiment, the composition contains a first additive consisting of a compound from the group of phosphinates, preferably aluminium diethylphosphinate. In another embodiment, the composition comprises the first additive and a second additive selected from zeolite and/or wollastonite and/or lithium carbonate and/or sodium borate or a mixture thereof. The first and second additives are a dimensional stabiliser. The advantages associated with these additives are described in the embodiments of the method of the invention.

In the context of the invention, a dimensional stabilizer is a substance which when added to a composition serves to prevent degradation of the product obtained from that composition. In the context of the invention, the product is a sand core and by degradation is meant decreasing the strength, intensity, or size of something, being in the context of the invention the size or dimension of the sand core.

In one embodiment, the proportions in the composition are as follows:
First additive, composed of the phosphinate group: 0.010% and 0.045% by weight with respect to the granulated sand material.
Second additive selected from zeolite and/or wollastonite and/or lithium carbonate and/or a mixture thereof: 0.1 and 0.6% by weight with respect to the granular sand material.
Binder compound: between 0.0 and 1.8% by weight of the granular sand material, preferably between 0.4 and 1.8%.

The technical features described in the various embodiments of the method of the invention and of the core of the invention apply to this aspect of the invention, giving rise to its various embodiments.

Several illustrative examples which clearly show the features and advantages of the invention are described below; however, they must not be interpreted as being limiting of the object of the invention as it is defined in the claims.

### Example 1: Making of Sand Cores According to an Embodiment

Sand cores were manufactured without the first and second additive (white) and with first and second additives, according to the additive manufacturing method with the Voxeljet printing machine model VX1000 for sand with inorganic binder.

### Materials Used:

Granulated sand material: AFS 100 silica sand with an average grain size of 150 μm.
Binder: sodium silicate based binder with a sodium silicate/water ratio of 35/65. 3.5% by weight of sand.
Binding agent: silicon dioxide. 0.4% in relation to the sand.

### Making Conditions:

Printing time: 1 h 42 min.
Dehydration curing time: 16 min.
Removal of uncured sand
Additional curing time: 6 minutes at 180° C.
Core ultimate strength: 330 N/cm².

Cores were made with the following additive ratios and one core of a formulation without additives as a control (Z):

| | | | | Additive 1 | Additive 2 |
|---|---|---|---|---|---|
| Formu- | | | | % by | as % by |
| lation | Type of | | | weight | weight |
| No. | additive | Additive 1 | Additive 2 | of sand | of sand |
| Z | — | — | — | — | — |
| 1 | Unique | Aluminium | — | 0.02 | |
| | | diethylphos- | | | |
| | | phinate | | | |
| 2A | Unique | — | Zeolite | | |
| 2B | Mix | Aluminium | Zeolite | 0.01 | 0.2 |
| | | diethylphos- | | | |
| | | phinate | | | |
| 3A | Unique | — | Wollastonite | | |
| 3B | Mix | Aluminium | Wollastonite | 0.01 | 0.2 |
| | | diethylphos- | | | |
| | | phinate | | | |
| 4A | Unique | — | Lithium | | |
| | | | carbonate | | |
| 4B | Mix | Aluminium | Lithium | 0.01 | 0.2 |
| | | diethylphos- | carbonate | | |
| | | phinate | | | |
| 5A | Unique | — | Sodium | | |
| | | | borate | | |
| 5B | Mix | Aluminium | Sodium | 0.01 | 0.2 |
| | | diethylphos- | borate | | |
| | | phinate | | | |

### Example 2: Study of the Dimensional Stability of Sand Cores Obtained in Example 1

The manufacturing dimensional stability is measured by comparing a series of points defined in the ideal CAD core model and the core manufactured according to Example 1. Once the two cores have been compared using a three-dimensional core measuring device, the deviation of the manufactured core at each of these points with respect to the ideal model has been measured. The deviation values at these points are collected in order to get a quantitative view of the dimensional stability.

If all points have deviations within set limits, the core is considered to comply with the required dimensional stability. There are two types of points: reference points and measuring points. On the one hand, the reference points are a total of 10 points which the three-dimensional measuring equipment takes as a reference to position the core in space. These points are the most important and therefore have the smallest deviation tolerance. On the other hand, there are the measuring points, 33 points, which are located on different parts of the core in order to evaluate only the difference to the model part. The following table shows the accepted dimensional tolerances in millimeters:

| | No. of | Minimum | Maximum |
|---|---|---|---|
| Point type | points | deviation (mm) | deviation (mm) |
| For reference | 10 | −0.10 | +0.10 |
| Measuring | 33 | −0.50 | +0.50 |

For the measurement, a structured light-based 3D measuring device (Solutionix C500) was used, which takes images around the manufactured core and joins them together to make a virtual model of the core for comparison with the ideal CAD model. In order to correctly reconstruct the virtual image of the manufactured core, it is necessary that the reference points are clear and comply with strict dimensional stability, because if the reference points are too far out of tolerance, the reconstructed image of the core is not entirely reliable.

FIGS. 3 to 8 show the graphs obtained from these measurements of the cores obtained in Example 1.

The x-axis shows the measuring points and the y-axis shows the deviation from the ideal tap measured in mm. The graph also includes the lines “RCT” representing the required core tolerances.

As can be seen in the data, the incorporation of the additives has improved the dimensional stability of the core obtained. The synergistic effect of aluminium diethylphosphinate when combined with the other additives is also relevant.

### Example 3: Dimensional Stability in Use Analysis Under Foundry Conditions

In order to reproduce the temperature conditions and to be able to quantify the behavior of the core under these conditions, the following procedure was followed:
Core making, which also includes a series of test pieces made of the same material as the core to check the printing quality. Cores and specimens were printed white (without additives) and cores and specimens were printed with aluminium diethylphosphinate (with 0.02% of aluminium diethylphosphinate by weight of the sand).
Performance of the Hot Distortion test, at a given time, always the same, on specimens with different dimensions (6.5 mm×115 mm and 25 mm×115 mm) suitable for the Hot Distortion test.

The Hot Distortion Test is a test commonly used in the foundry industry to predict the response of a core to increasing temperature. In this way it is possible to see the resistance of a core of a particular formulation to brittleness, expansion and deformation at the same casting temperatures.

### Specimen Composition and Manufacturing Parameters:

a) with the Conventional (Blow Molding) Machine Making Method:
A homogeneous mixture of granulated sand material, binding compound, aluminium diethylphosphinate and binder (resin) is prepared. First ensure that the solid material is properly homogenised and then mix it with the resin.
A Morek laboratory blow molding machine is used for blowing the specimens. The mixture made in the previous step is loaded into the head of the machine. The blowing and curing of the specimens is carried out according to the parameters specified below.
In order to be able to fire specimens with the standard dimensions for the ‘Hot Distortion’ test (6.5 mm×115 mm and 25 mm×115 mm), a specific tooling is used with traces adapted to the described dimensions.

### Composition of Specimens:

| | | | | Aluminium |
|---|---|---|---|---|
| | | | | diethylphosphinate |
| | | | Binder | (% by weight |
| | | Resin | Compound | of sand)* |
| Test | | (% by weight | (% by weight | (% by weight |
| tube | Sand | of sand) | of sand) | of sand) |
| 1S | silica | 1.8% sodium | 1% siliceous | 0.02% |
| | sand | silicate/water | based binder | |
| | AFS 55 | 35/65 ratio | powder | |
| 1SB | silica | 1.8% 1.8% 1.8% | 1% siliceous | |
| | sand | sodium silicate | based binder | |
| | AFS 55 | water 35/65 ratio | powder | |

### Blowing Parameters of Laboratory Blow Molding Equipment:

| | | |
|---|---|---|
| Tooling temperature | (° C.) | 140-170 |
| Hot air temperature | (° C.) | 150-180 |
| Hot air curing time | (seconds) | 20-40 |

b) with the Additive Manufacturing Method:

Manufacturing parameters: Identical to those described in Example 1.

### Composition of Specimens:

| | | | | | Aluminium |
|---|---|---|---|---|---|
| | | | Binding | Binder | diethylphos- |
| | | Resin | compound | Compound | phinate |
| | | (% by | (% by | (% by | (% by |
| Test | | weight | weight | weight | weight |
| tube | Sand | of sand) | of sand) | of sand) | of sand) |
| 1FA | silica | 4% sodium | 0.8% silica | 0.02% | 0.02% |
| | sand | silicate/water | based binder | organosilicic | |
| | AFS | 35/65 ratio | powder | surfactant | |
| | 100 | | | liquid | |
| 1FAB | Silica | 4% sodium | 0.8% silica | 0.02% | |
| | sand | silicate/water | based binder | organosilicic | |
| | AFS | 35/65 ratio | powder | surfactant | |
| | 100 | | | liquid | |

### c) Hot Distortion Test

The Hot Distortion equipment has a source of flammable gas that is ignited, which provides the heat source, a support for the specimen and a distance sensor. For a set time, the sand specimen is subjected to the flame, regulated to meet the appropriate casting temperature, and the distance sensor registers how far the specimen moves away from the original position. It should be borne in mind that the natural tendency of the specimen is that, due to the effect of the heat focused on the central point, it gradually bends downwards.

The parameters for the Hot Distortion Test were:

| Parameter | Value | |
|---|---|---|
| Time | 5 | min |
| Position register | 120 | registers/min |
| Temperature | 650 | C ° |

| | |
|---|---|
| Gas passage | ¼ turn |

Hot Distortion Results with Additive Manufacturing:

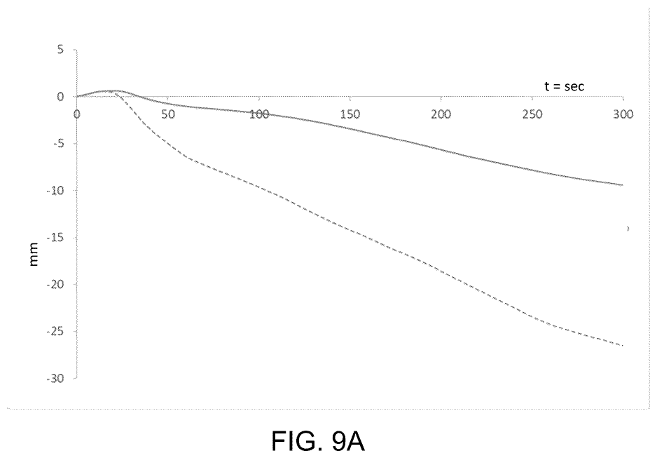

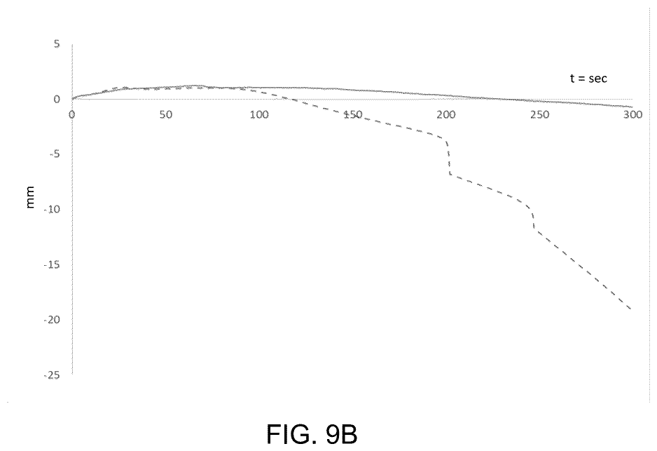

The average deformation of the specimens with aluminium diethylphosphinate was 9.42 mm, compared to 26.5 mm for the blank specimens at the end of the study. The deformation is considerably lower due to the effect of aluminium diethylphosphinate as can be seen in FIG. 9A, the solid line corresponding to the specimen containing aluminium diethylphosphinate and the dashed line corresponding to the specimen without aluminium diethylphosphinate.

Hot Distortion Results with Blowing:

The average deformation of the specimens with aluminium diethylphosphinate was 0.72 mm compared to 19.2 mm for the blank specimens at the end of the study. The deformation is considerably lower due to the effect of aluminium diethylphosphinate, as can be seen in FIG. 9B, the solid line corresponding to the specimen comprising aluminium diethylphosphinate and the dashed line to the specimen without aluminium diethylphosphinate.

Embodiments are disclosed in the clauses that follow.

Clause 1. Sand core comprising a granular sand material and at least one binder, the core comprising an additive selected from a compound of the phosphinate group.

Clause 2. Sand core according to clause 1, wherein the phosphinate group compound is an aluminium diethylphosphinate.

Clause 3. Sand core according to clause 1 or 2, wherein the sand granulate material comprises sand selected from silica sand, chromite sand, zircon sand, olivine sand, bauxite, mullite and/or any sand of synthetic type, preferably with a grain diameter between 100 μm and 425 μm.

Clause 4. Sand core according to any one of the preceding clauses, wherein the binder is an inorganic binder.

Clause 5. Sand core according to any one of the preceding clauses, wherein the core comprises a second additive selected from zeolite and/or wollastonite and/or lithium carbonate and/or sodium borate or a mixture thereof.

Clause 6. Method of making sand cores comprising a first step of contacting or mixing a granular sand material and at least one binder and a second step of curing, characterised in that the granular sand material or the mixture of granular material and binder comprises an additive selected from a compound of the phosphinate group.

Clause 7. Method according to clause 6, wherein the compound is an aluminium diethylphosphinate.

Clause 8. Method according to clause 6 or 7, wherein the percentage by weight of the compound of the phosphinate group or the aluminium diethylphosphinate with respect to the granular material is between 0.01 and 0.045%.

Clause 9. Method according to any of clauses 6 to 8, wherein the method of making is by additive manufacturing, being the first contacting step by an application of a plurality of layers of a mixture (2) of granular sand material and the phosphinate group compound and a plurality of layers of a binder (3) in an interspersed manner, on a working platform (1) and the second curing step by an increase of temperature of the layers, preferably by a heat input and/or dehydration method.

Clause 10. Method according to clause 9, wherein the mixture (2) comprises a second additive selected from zeolite and/or wollastonite and/or lithium carbonate and/or sodium borate or a mixture thereof wherein the percentage by weight of the second additive with respect to the granular sand material is between 0.1 and 0.6%.

Clause 11. Method according to clause 9 or 10, wherein the granular sand material comprises sand selected from silica sand, chromite sand, zircon sand, olivine sand, bauxite, mullite and/or any sand of synthetic character with a grain diameter between 100 μm and 300 μm.

Clause 12. Method according to any of clauses 9 to 11 comprising a third step of removing the uncured granular sand material.

Clause 13. Method according to any of clauses 6 to 12, wherein the binder is an inorganic binder, wherein the percentage by weight of the binder with respect to the granular material is between 1.5% and 6%.

Clause 14. Sand core obtainable according to the making method according to any of clauses 6 to 13, for use in metal casting, preferably iron, aluminium, copper or aluminium casting.

What is claimed is:

1. A sand core comprising:
a granular sand material;
at least one inorganic binder; and
a first additive that is a phosphinate group compound, the phosphinate group compound being aluminium diethylphosphinate.

2. The sand core according to claim 1, wherein the granular sand material comprises sand selected from the group consisting of silica sand, chromite sand, zircon sand, olivine sand, bauxite, mullite and a synthetic sand, grains of the granular sand material having a grain diameter of 100 μm to 425 μm.

3. The sand core according to claim 1, wherein the core comprises a second additive selected from the group consisting of zeolite, wollastonite, lithium carbonate and sodium borate.

4. The sand core according to claim 2, wherein the core comprises a second additive selected from the group consisting of zeolite, wollastonite, lithium carbonate and sodium borate.

5. The sand core according to claim 1, wherein the core comprises a second additive that is a mixture of two or more of the group consisting of zeolite, wollastonite, lithium carbonate and sodium borate.

6. The sand core according to claim 1, wherein a percentage by weight of the phosphinate group compound with respect to the granular sand material is 0.01% to 0.045%.

7. The sand core according to claim 3, wherein a percentage by weight of the second additive with respect to the granular sand material is 0.1% to 0.6%.

8. The sand core according to claim 5, wherein a percentage by weight of the second additive with respect to the granular sand material is 0.1% to 0.6%.

9. The sand core according to claim 2, wherein a percentage by weight of the inorganic binder with respect to the granular sand material is 1.5% to 6%.

10. The sand core according to claim 1, wherein the inorganic binder comprises particles selected from the group consisting of silicon dioxide, aluminium oxide, titanium oxide and zinc oxide.

11. The sand core according to claim 10, wherein the particles have a size of 0.10 μm to 1 μm.

12. A method of making a sand core comprising:
contacting or mixing a granular sand material containing a phosphinate group compound with at least one inorganic binder, the phosphinate group compound being aluminium diethylphosphinate; and
curing the at least one inorganic binder.

13. The method according to claim 12, wherein a percentage by weight of the phosphinate group compound with respect to the granular sand material is 0.01% to 0.045%.

14. The method according to claim 12 comprising an additive manufacturing process, the additive manufacturing process comprising:
sequentially depositing on a platform layers of the granular sand material containing the phosphinate group compound;
depositing on each layer of the granular sand material containing the phosphinate group compound a layer of the binder such that the layers of binder are interspersed between the layers of the granular sand material containing the phosphinate group compound; and
applying heat to the deposited layers of the granular sand material containing the phosphinate group compound and to the deposited layers of the binder.

15. The method according to claim 12, wherein the granular sand material containing the phosphinate group compound includes an additive selected from the group consisting of zeolite, wollastonite, lithium carbonate and sodium borate.

16. The method according to claim 12, wherein the granular sand material comprises sand selected from the group consisting of silica sand, chromite sand, zircon sand, olivine sand, bauxite, mullite and synthetic sand.
